(19) United States
(12) Patent Application Publication
(10) Pub. No.: US 2026/0205655 A1
(43) Pub. Date: Jul. 16, 2026

(54) SYSTEMS AND METHODS FOR ACTIVITY-BASED VIEWING

(71) Applicant: Comcast Cable Communications, LLC, Philadelphia, PA (US)

(72) Inventors: Chris Whitely, New York, NY (US); Zhao Xing, New York, NY (US); Liu Su, New York, NY (US)

(21) Appl. No.: 19/020,960

(22) Filed: Jan. 14, 2025

(51) Int. Cl. H04N 21/442

(52) U.S. Cl. CPC H04N 21/44204

(57) ABSTRACT

Methods may include receiving, via one or more user devices, a signal indicative of activity data, where the activity data relates to one or more viewing sessions of a plurality of viewing sessions associated with the one or more user devices. Methods may include determining, based at least on the activity data, one or more user-initiated events and one or more machine-initiated events. Methods may include determining, based at least on the one or more user-initiated events and the one or more machine-initiated events, an active viewing time. Methods may include generating, based on the active viewing time, a viewing threshold.

### BACKGROUND

Several techniques exist for monitoring user access or attention to content resources such as advertisements and/or other content. Current solutions may include tracking media impressions, for example. It may be difficult to determine if a user is paying attention to content resources being accessed by a user device.

However, improvements are needed.

### SUMMARY

It is to be understood that both the following general description and the following detailed description are exemplary and explanatory only and are not restrictive. Methods and systems for managing wireless communications are described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Methods may include receiving, via one or more user devices, a signal indicative of activity data, wherein the activity data relates to one or more viewing sessions of a plurality of viewing sessions associated with the one or more user devices. Methods may also include determining, based at least on the activity data, one or more user-initiated events and one or more machine-initiated events. Methods may furthermore include determining, based at least on the one or more user-initiated events and the one or more machine-initiated events, an active viewing time. Methods may in addition include generating, based on the active viewing time, a viewing threshold. Other embodiments of this aspect include corresponding computer systems, apparatus, and computer programs recorded on one or more computer storage devices, each configured to perform the actions of the methods.

Methods may include receiving, via a user device, a signal indicative of activity data, where the activity data relates to one or more viewing sessions of a plurality of viewing sessions associated with the user device. Methods may also include determining, based at least on the activity data, one or more user-initiated events and one or more machine-initiated events. Methods may furthermore include determining, based at least on the one or more user-initiated events and the one or more machine-initiated events, an active viewing time. Methods may in addition include updating, based on the active viewing time, a viewing threshold. Other embodiments of this aspect include corresponding computer systems, apparatus, and computer programs recorded on one or more computer storage devices, each configured to perform the actions of the methods.

Methods may include determining, at a user device and at one or more time intervals, one or more machine-initiated events indicative of a status of the user device at the one or more time intervals. Methods may also include determining, at the user device, one or more user-initiated events having a user activity and a user activity time. Methods may furthermore include causing transmission of a signal from the user device, where the signal is indicative of activity data relating to one or more viewing sessions of a plurality of viewing sessions associated with the user device over a period of time, where the signal may include at least the one or more user-initiated events and the one or more machine-initiated events, and where the signal indicates the one or more time intervals within the period of time. Other embodiments of this aspect include corresponding computer systems, apparatus, and computer programs recorded on one or more computer storage devices, each configured to perform the actions of the methods.

This summary is not intended to identify critical or essential features of the disclosure, but merely to summarize certain features and variations thereof. Other details and features will be described in the sections that follow.

### BRIEF DESCRIPTION OF THE DRAWINGS

Some features are shown by way of example, and not by limitation, in the accompanying drawings. In the drawings, like numerals reference similar elements.

FIG. 1 shows an environment in which the systems and methods described herein may operate.

FIG. 2 shows an example process described herein.

FIG. 3 may show a set of data from signals indicative of heartbeats of a content receiver.

FIG. 4 show example data structures comprising heartbeat data.

FIG. 5 shows an example process described herein.

FIG. 6 shows a bar graph showing session length by session type.

FIG. 7 shows a visual representation for methods for capturing viewing activity in viewing sessions.

FIG. 8 is a flow diagram illustrating a process for determining user-initiated events.

FIG. 9 is a block diagram illustrating a process for receiving a signal indicative of activity data.

FIG. 10 is a block diagram illustrating a process for determining a time interval based on the receipt of the indicated activity data.

The accompanying drawings show examples of the disclosure. It is to be understood that the examples shown in the drawings and/or discussed herein are non-exclusive and that there are other examples of how the disclosure may be practiced.

### DETAILED DESCRIPTION

This disclosure relates generally to advertisement-related metrics and data analysis related to length of viewing sessions. For example, data based on how long a video player was powered on may indicate that a viewing session lasted 10 hours, but the metric may be improved and adjusted based on last user activity, such as the last time a channel was changed. Viewing activity data may be analyzed and categorizing into (1) user-initiated events, such as channel or volume changes, trick play commands, etc., and (2) machine-initiated events, such as screen savers launching, system reboots or software updates, etc. After categorizing, the activity data may be used to adjust the length of a viewing session. As an example, user-initiated events may be given more weight than machine-generated events, and machine-generated event data may be adjusted and mapped onto the user-generated event data. As another example, the viewing activity data is used to adjust the viewing session durations to better determine exposure to particular content, such as advertisements. Additionally or alternatively, the activity data may be used to adjust a capping threshold relating to insertion of ad events.

As an illustration, a user may view content via one or more platforms, including, for example, a set-top-box or other content device. As an illustrative example, certain viewing activities of the user may be determined from viewing data. One or more events, user activities, or device conditions may be determined. Determining (e.g., gathering) such viewing activities may comprise creating sessions based on one or more of channel tunes, remote control button and/or microphone interaction, power states of devices, such as set-top boxes, video players, etc., or signals from content data.

A filtered set or “truth set” of linear viewing data may be generated from determined viewing data. Generating the truth set of linear viewing data may comprise one or more of removing inactive user time or adjusting machine terminated events, for example to match a set distribution of user terminated events.

Based at least on one or more of the viewing data or filtered set of viewing data, viewing capped thresholds may be generated based on an initial capped threshold and then editing the capped threshold based on viewing sessions. Viewing sessions may be created based on viewing start times and a last user activity. The capped thresholds may be edited to match with verified user time volume levels.

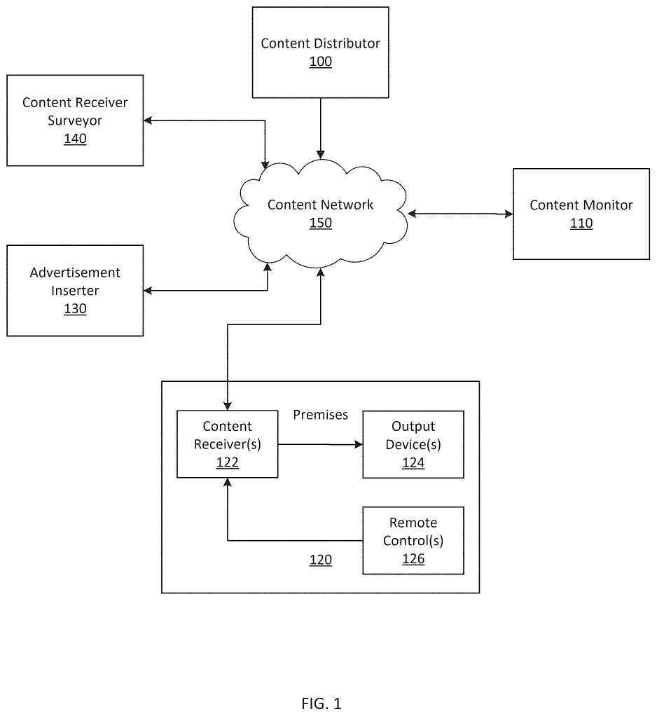

FIG. 1 shows an environment in which the systems and methods described herein may operate. The environment may comprise a content distributor 100, a content monitor 110, one or more premises 120, an advertisement inserter 130, a content receiver surveyor 140, and a content network 150. The one or more premises 120 may comprise one or more content receiver(s) 122, one or more output device(s) 124, and one or more remote control(s) 126.

The content distributor 100 may comprise a headend. The content distributor 100 may comprise a hub. The content distributor 100 may comprise a server. The content distributor 100 may cause one or more signal(s) indicative of content to be transmitted via the content network 140 and for reception by the one or more content receiver(s) 122 at the one or more premises 120. The one or more signal(s) indicative of content may comprise one or more signal(s) indicative of audio content. The one or more signal(s) indicative of content may comprise one or more signal(s) indicative of image content. The one or more signal(s) indicative of content may comprise one or more signals indicative of video signal(s). The one or more signal(s) indicative of content may comprise one or more signal(s) indicative of interactive context. The one or more signal(s) indicative of content may comprise one or more signal(s) indicative of one or more video game(s). The content distributor 100 may be associated with a content provider.

The content monitor 110 may monitor content distributed via the content network 140. The content monitor 110 may assign a rating (ranking, viewership score, etc.) to a program distributed via the content network 140. The content monitor 110 may assign the rating based on a number of the one or more content receiver(s) 122 configured to receive the program. The content monitor 110 may assign the rating based on a percentage of the one or more content receiver(s) 122 configured to receive the program. The content monitor 110 may assign the rating based on demographic associated with viewership on the one or more content receiver(s) 122 configured to receive the program. The content monitor 110 may adjust the rating based on determining that one or more of the one or more content receiver(s) 122 configured to receive the program have no corresponding viewer. The content monitor 110 may be associated with the content provider.

A content receiver 122 may be configured to receive the program if the content receiver 122 receives the program. A content receiver 122 may be configured to receive the program if the content receiver is tuned to a channel displaying the program. A content receiver 122 may be configured to receive the program if the content receiver 122 requests the program. A content receiver 122 may be configured to receive the program if the content receiver 122 comprises a data stream comprising the program.

The one or more premises 120 may be associated with one or more subscriber(s) of the content provider. The one or more premises 120 may comprise a residential premises. The one or more premises 120 may comprise a commercial premises. The one or more premises 120 may comprise an industrial premises. The one or more content receiver(s) 122 may comprise a set-top box. The one or more content receiver(s) 122 may comprise a video player. The one or more content receiver(s) 122 may comprise a modem. The modem may comprise a cable modem. The modem may comprise a fiber optic modem. The one or more content receiver(s) 122 may comprise a gateway. The one or more output device(s) 124 may comprise a screen. The one or more output device(s) 124 may comprise a speaker. The one or more remote control(s) 126 may comprise input components. The input components may comprise one or more pressable button(s). The input components may comprise one or more microphone(s). The one or more remote control(s) 126 may facilitate control of the one or more content receiver(s) 122. The one or more remote control(s) 126 may facilitate interaction with content presented via the one or more content receiver(s) 122.

The advertisement inserter 130 may cause advertisements to be inserted into content distributed via the content network 150. The advertisement inserter 130 may be associated with the content provider. Content distributed via the content network 150 may comprise an indication for dynamic advertisement insertion. The advertisement inserter 130 may insert an advertisement in content distributed via the content network 150 at the indication for dynamic advertisement insertion.

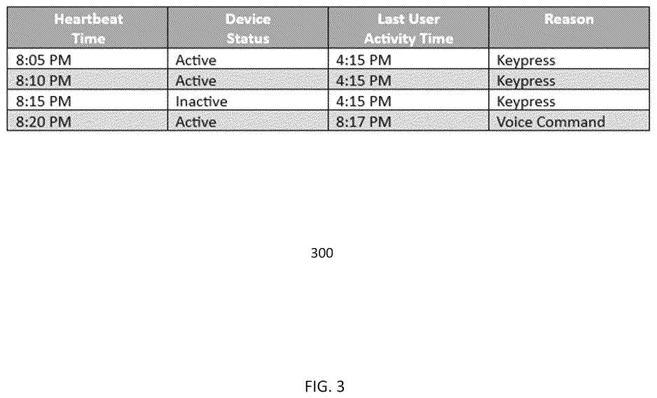

The content receiver surveyor 140 may survey (poll, audit, etc.) the one or more content receiver(s) 122 to determine a heartbeat (snapshot, update, etc.) of the one or more content receiver(s) 122. The content receiver surveyor 140 may receive the heartbeat from the one or more content receiver(s) 122. The heartbeat may comprise a state (status, mode, etc.). The heartbeat may comprise a last user interaction (engagement, activity, etc.). The heartbeat may comprise a time associated with the last user interaction. The heartbeat may comprise a time the heartbeat was established. The content receiver surveyor 140 may survey the one or more content receiver(s) 122 to retrieve a set (array, list, etc.) of heartbeats. The content receiver surveyor 140 may infer a new state based on the heartbeat and/or set of heartbeats. The content receiver surveyor 140 may be associated with the content provider. The content receiver surveyor 140 may comprise and/or be in communication with a Hypertext Transfer Protocol (HTTP) collector, such as an HTTP event collector or an HTTP data collector. The content receiver surveyor 140 may comprise and/or be in communication with an aggregator of telemetry data. The content receiver surveyor 140 may create and/or receive logs comprising telemetry data. Heartbeats will be described in more detail in reference to FIG. 3.

The content network 150 may enable distribution of content from the content distributor 100 to the one or more content receiver(s) 122. The content network 150 may be associated with the content provider. The content network 150 may comprise a cable network. The content network 150 may comprise a fiber optic network.

The content receiver surveyor 140 may receive a signal from a first content receiver 122 of the one or more content receiver(s) 122 via the content network 150. The signal may be indicative of activity data. The activity data may relate to one or more viewing sessions on the first content receiver 122. The content receiver surveyor 140 may determine one or more user-initiated events associated with the first content receiver 122. The content receiver surveyor 140 may determine one or more machine-initiated events associated with the first content receiver 122. The content receiver surveyor 140 may determine an active viewing time based at least on the one or more user-initiated events and the one or more machine-initiated events. The content receiver surveyor 140 may generate a viewing threshold based on the active viewing time.

A user at a first premise 120 of the one or more premises 120 may use a first remote control 126 of the one or more remote control(s) 126 to cause a first content receiver 122 of the one or more content receiver(s) 122 to receive a first program via the content network 150 for presentation of a first output device 124 of the one or more output device(s) 124 at 8:00 PM. The first program may comprise a three-hour baseball game. At 11:00PM, the first content receiver 122 may receive a second program. The second program may follow the first program on a channel.

The second program may comprise an infomercial. At 11:15 PM, the content receiver surveyor 140 may receive a signal from the first content receiver 122 via the content network 150. The signal may indicate that the user last interacted with the first content receiver 122 at 8:00 PM via a button press on the first remote control 126. The signal may indicate that the last interaction was a channel press. The content receiver surveyor 140 may determine that the user is no longer consuming the content presented by the first content receiver 122. The content receiver surveyor 140 may cause the first content receiver 122 to enter a sleep mode.

If the content receiver surveyor 140 receives an indication from the first content receiver 122 that the user caused the first content receiver 122 to exit the sleep mode within a sleep threshold time, then the content receiver surveyor 140 may determine that the determination that the user was no longer consuming the content was incorrect. The sleep threshold time may be a short time, such as five minutes. The sleep threshold time may be a time a next signal is transmitted from the content receiver surveyor 140 to the first content receiver 122. If the content receiver surveyor 140 receives an indication from the first content receiver 122 is still in the sleep mode after the sleep threshold time, then the content receiver surveyor 140 may determine that the determination that the user was no longer consuming the content was correct and the content receiver surveyor 140 may adjust a viewing threshold. The viewing threshold may be adjusted based on an inactive time. The viewing threshold may be adjusted to three hours and fifteen minutes.

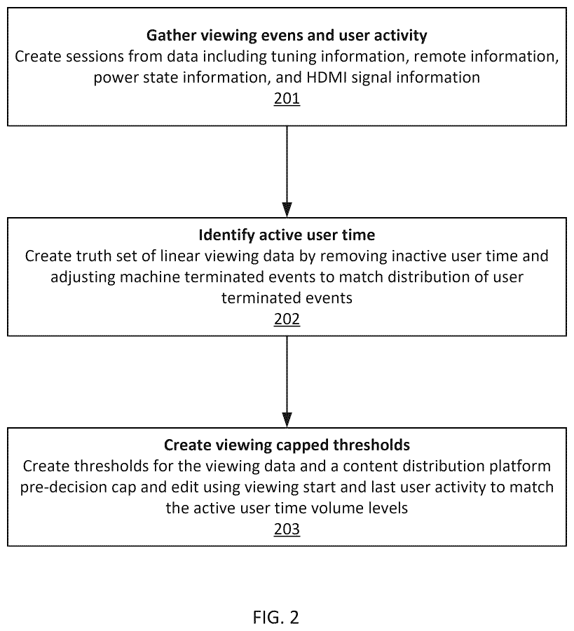

FIG. 2 shows an example process described herein. The process may comprise step 201 of gathering viewing events and user activities. Gathering viewing events and user activities may comprise creating sessions based on one or more of channel tunes, remote control button and/or microphone interaction, power states of devices, such as set-top boxes, video players, etc. and signals from content data.

The process may comprise step 202 of identifying active user time. Identifying active user time may comprise creating a truth set of linear viewing data. Creating the truth set of linear viewing data may comprise removing inactive user time and adjusting machine terminated events to match distribution of user terminated events.

The process may comprise step 203 of creating viewing capped thresholds. Creating viewing capped thresholds may comprise creating an initial capped threshold and then editing the capped threshold based on viewing sessions. Viewing sessions may be created based on viewing start times and a last user activity. The capped thresholds may be edited to match with verified user time volume levels.

FIG. 3 may show a set 300 of data from signals indicative of heartbeats (snapshots, updates, etc.) of a content receiver. The content receiver may comprise an inactivity threshold of four hours. As shown, the set 300 of heartbeats comprise four heartbeats. A first heartbeat was observed at 8:05 PM. A second heartbeat was observed at 8:10 PM. A third heartbeat was observed at 8:15 PM. A fourth heartbeat was observed at 8:20 PM. The first heartbeat indicated that the content receiver was active based on a first user interaction, and the first user interaction comprised a keypress of a remote control at 4:15 PM—the time that has passed was three hours and fifty minutes and did not satisfy the inactivity threshold. The second heartbeat indicated that the content receiver was active based on the first user interaction—the time that has passed was three hours and fifty-five minutes and did not satisfy the inactivity threshold. The third heartbeat indicated that the content receiver was inactive based on the first user interaction—the time that has passed was four hours and did satisfy the inactivity threshold. In response to going inactive, the content receiver may enter a sleep mode. The content receiver may cause an associated screen to enter a screen saver mode. The fourth heartbeat indicated that the content receiver was active based on a second user interaction, and the second user interaction comprised a voice command associated with the remote control at 8:17 PM—the time that has passed is three minutes and did not satisfy the inactivity threshold.

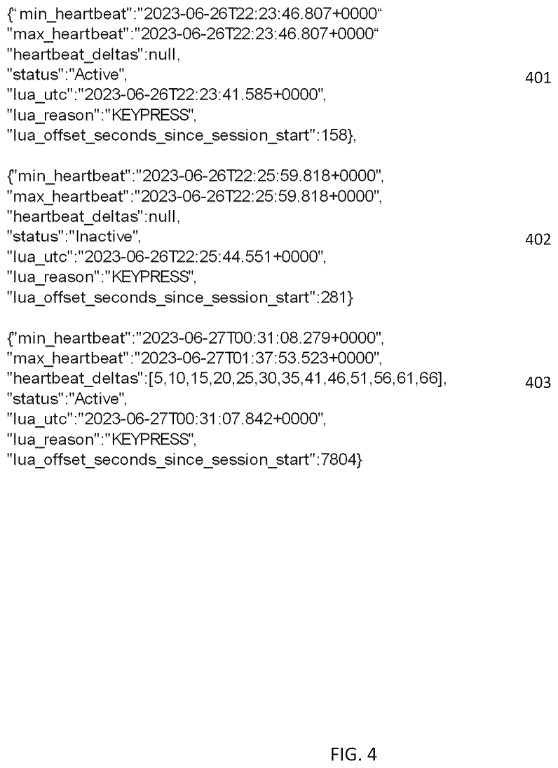

FIG. 4 show example data structures 401-403 comprising heartbeat data. The data structures comprise a time associated with a first heartbeat of a set (min_heartbeat), a time associated with a last heartbeat of the set (max_heartbeat), an indication of heartbeats in the set (heartbeat_deltas), a status of an associated content receiver (status), a time associated with a last user activity (lua_utc), a reason for the status (lua_reason), and a time between the last user activity and a start time of a viewing session associated with the heartbeat data (lua_offset_seconds_since_session_start). The time associated with the first heartbeat of the set may comprise a first timestamp. The time associated with the last heartbeat of the set may comprise a second timestamp. The indication of the heartbeats in the set may comprise an array. The values in the array may indicate an offset, in time, of an associated heartbeat from the first heartbeat. The offset may be in minutes, seconds, etc. If there are less than two heartbeats in the set, then the indication of the heartbeats in the set may comprise a null value.

The status of the associated content receiver may comprise an indication of the status. Example indications of the status of the content receiver may comprise active, inactive, etc. The time associated with a last user activity may comprise a third timestamp. The reason for the status may comprise an indication of the reason for the status. Example indications of the reason of the status comprise keypress, voice command, ghost commands (commands that happen before a viewing session, such as power on, etc.), high-definition multimedia interface (HDMI) consumer electronics control (CEC) commands, etc. The time between the last user activity and the start time of the viewing session associated with the heartbeat data may comprise a value indicative of the timein seconds, minutes, etc.

A first data structure 401 may comprise a first single heartbeat. The first single heartbeat may be indicative of an active content receiver because a keypress happened within an inactivity threshold. A second data structure 402 may comprise a second single heartbeat. The second single heartbeat may be indicative of an inactive content receiver because a keypress was the last user activity and the keypress happened outside an inactivity threshold. A third data structure 403 may comprise fourteen heartbeats, spanning sixty-six minutes. A last of the fourteen heartbeats may be indicative of an active content receiver because a keypress happened within an inactivity threshold.

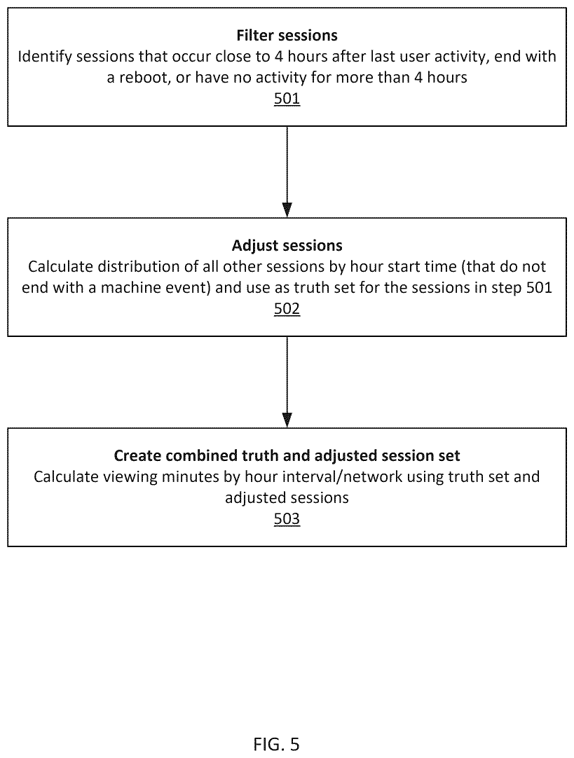

FIG. 5 shows an example process described herein. The process may comprise step 501 of filtering sessions. Filtering sessions may comprise identifying sessions that occur close to an inactivity threshold after last user activity, end with a reboot, or have no activity for the inactivity threshold. The inactivity threshold may comprise, for example four hours. The process may comprise step 502 of adjusting sessions. Adjusting sessions may comprise calculating distribution of other sessions hour start time. The other sessions that end with a machine event may be excluded and a remaining set of sessions may remain. The remaining set of sessions may be used as a truth set for sessions identified in step 501. The process may comprise step 503 of creating a combined truth and adjusted session set. Creating the combined truth and adjusted session set may comprise calculating viewing minutes by hour interval and/or by network using the truth set and the adjusted sessions.

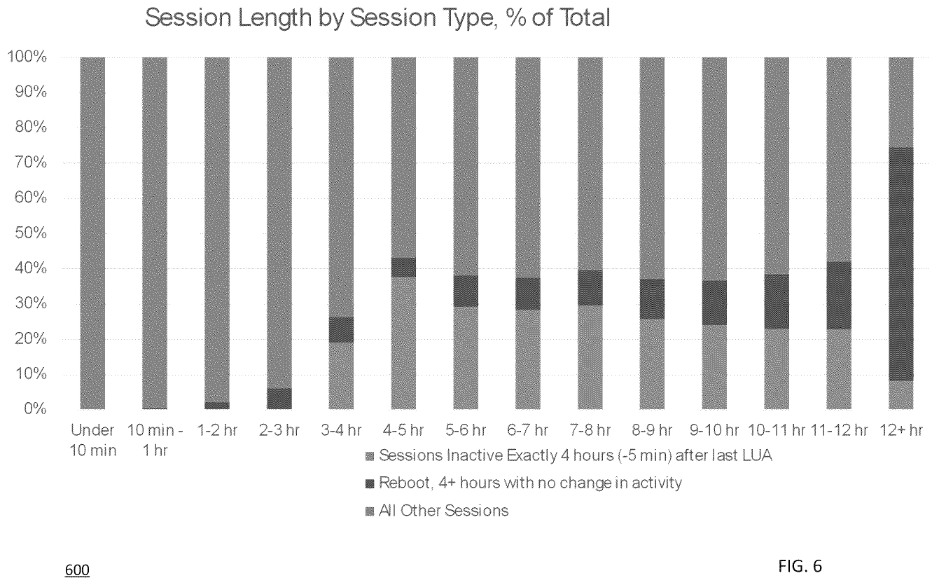

FIG. 6 shows a bar graph showing session length by session type. The vertical axis of the bar graph shows percentages, in increments of 10%. The horizontal axis shows the session length, starting at under 10 minutes, then 10 minutes to 1 hour, then moving up in one hour increments before ending on 12 hours and more. Each bar represents 100% of the viewing sessions for a corresponding session length. All of the bars from a bar representing session lengths of 3-4 hours to a bar representing session lengths of 12 hours and more have three segments. A bottom segment of the three segments may represent when a viewing session has turned inactive, as an inactivity threshold (in this case, 4 hours) has been satisfied. Satisfying the inactivity threshold may mean that a time since user activity has been detected is greater than the inactivity threshold. In response to determining that a viewing session has satisfied the inactivity threshold, the viewing session may be declared (toggled, adjusted to, etc.) inactive. In response to determining that a viewing session has satisfied the inactivity threshold, the viewing session may be terminated (ended, etc.).

A bar representing session lengths of 1-2 hours and a bar representing session lengths of 2-3 hours each have two segments. A bottom segment of the two segments as well as a middle segment of three segment bars (middle segment) may represent a viewing session with a reboot. The middle segment may also represent that 4 or more hours have passed with no activity and a device associated with the viewing session has not toggled from active to inactive.

A bar representing session lengths of under 10 minutes and a bar representing session lengths of 10 minutes to 1 hour each have one segment. The one segments, as well as a top segment of the two segment bars and a top segment of the three segment bars (top segment) may represent every viewing session not represented by the middle segment and the bottom segment. The top segment may represent active viewing sessions.

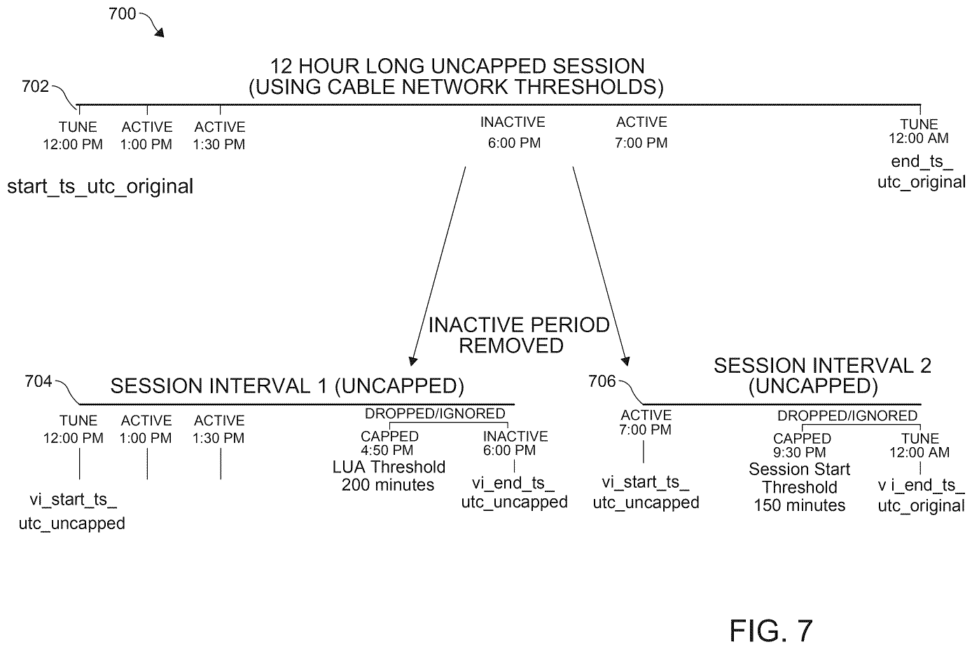

FIG. 7 shows a visual representation 700 for methods for capturing viewing activity in viewing sessions. The visual representation 700 may comprise a top timeline 702, a first bottom timeline 704, and a second bottom timeline 706. The top timeline 702 may show a first method for capturing viewing activity at a content receiver. The first bottom timeline 704 and the second bottom timeline 706 may show a second method for capturing the viewing activity at the content receiver.

The viewing activity may comprise a user initiating a viewing session at noon. Initiating the viewing session may comprise powering up the content receiver. Initiating the viewing session may comprise tuning the content receiver to a channel. The viewing activity may comprise detected user activity associated with the content receiver at 1:00 PM. The user activity may comprise changing a channel, changing a volume, engaging in trick play, initiating streaming content, launching an application, etc. The viewing activity may comprise detected user activity associated with the content receiver at 1:30 PM. The viewing activity may comprise detecting that the content receiver entered an inactive status at 6:00 PM. The viewing activity may comprise detected user activity associated with the content receiver at 7:00 PM. The viewing activity may comprise the user terminating the viewing session at midnight. Terminating the viewing session may comprise, for example, powering down the content receiver.

The top timeline 702 may comprise a 12 hour long uncapped representation of viewing activity. A first data structure representing the viewing activity in a manner suggested by the top timeline 702 may comprise an entry comprising heartbeat information every predetermined increment of time starting at noon and ending at midnight. The predetermined increment of time may be, for example, five minutes. Entries in the first data structure representing heartbeat information from noon to or before 1:00 PM may comprise an indication of the initiation of the viewing session. Entries in the first data structure representing heartbeat information on or after 1:00 PM to or before 1:30 PM may comprise an indication of user activity at 1:00 PM. Entries in the first data structure representing heartbeat information on or after 1:30 PM to or before 6:00 PM may comprise an indication of user activity at 1:30 PM. Entries in the first data structure representing heartbeat information on or after 6:00PM to or before 7:00 PM may comprise an indication of an inactive status associated with the content receiver. Entries in the first data structure representing heartbeat information on or after 7:00 PM to or before midnight may comprise an indication of user activity at 7:00 PM.

The second method for capturing the viewing activity at the content receiver as shown by the first bottom timeline 704 and the second bottom timeline 706 may comprise two viewing thresholds. A first viewing threshold may comprise a session start threshold. The session start threshold may be in effect when a viewing session begins. The session start threshold may end when either a user activity is detected or the session start threshold is satisfied. The session start threshold may comprise any time, such as, for example, 150 minutes. A second viewing threshold may comprise a last user activity threshold. A countdown to the last user activity threshold may be initiated and/or reset when user activity is detected. An active last user activity threshold may be ended and/or reset when user activity is detected. An active last user activity threshold may end when the last user activity threshold is satisfied. The last user activity threshold may comprise any time, such as, for example, 200 minutes.

The first bottom timeline 704 may comprise a 4 hour and 50 minute capped representation of the viewing activity from noon to 4:50 PM. A second data structure representing the viewing activity in a manner suggested by the first bottom timeline 704 may comprise an entry comprising heartbeat information every predetermined increment of time starting at noon and ending at 4:50 PM. The predetermined increment of time may be, for example, five minutes. Entries in the second data structure representing heartbeat information from noon to or before 1:00 PM may comprise an indication of the initiation of the viewing session. Prior to detection of the user activity at 1:00 PM, a session associated with the viewing activity starting at noon may comprise a viewing threshold comprising a session start threshold. The session start threshold may be 150 minutes, and the session may end at 1:30 PM, unless user activity is detected.

At 1:00 PM, user activity may be detected. The viewing threshold may stop using the session start threshold and begin using a last user activity threshold. The last user activity may be keyed to the user activity detected at 1:00 PM. The user activity threshold may be 200 minutes, and the session may end at 4:20 PM, unless additional user activity is detected. Entries in the second data structure representing heartbeat information on or after 1:00 PM to or before 1:30 PM may comprise an indication of user activity at 1:00 PM.

At 1:30 PM, user activity may be detected. The viewing threshold may reset the last user activity threshold to be keyed to the user activity detected at 1:30 PM. The user activity threshold may be 200 minutes, and the session may end at 4:50 PM, unless additional user activity is detected. Entries in the second data structure representing heartbeat information on or after 1:30 PM to or before 4:50 PM may comprise an indication of user activity at 1:30 PM.

At 4:50 PM, the viewing threshold may be satisfied. In response to the viewing threshold being satisfied, heartbeat information on or after 4:50 PM may be excluded from the second data structure.

The second bottom timeline 706 may comprise a 1 hour and 30 minute capped representation of the viewing activity from 7:00 PM to 9:30 PM. A session associated with the viewing activity starting at 7:00 PM may comprise a viewing threshold comprising a session start threshold. The session start threshold may be 150 minutes, and the session may end at 9:30 PM, unless user activity is detected. A third data structure representing the viewing activity in a manner suggested by the second bottom timeline 706 may comprise an entry comprising heartbeat information every predetermined increment of time starting at 7:00 PM and ending at 9:30 PM. The predetermined increment of time may be, for example, five minutes. Entries in the third data structure representing heartbeat information may comprise an indication of user activity at 7:00 PM. At 9:30 PM, the viewing threshold may be satisfied. In response to the viewing threshold being satisfied, heartbeat information on or after 9:30 PM may be excluded from the third data structure.

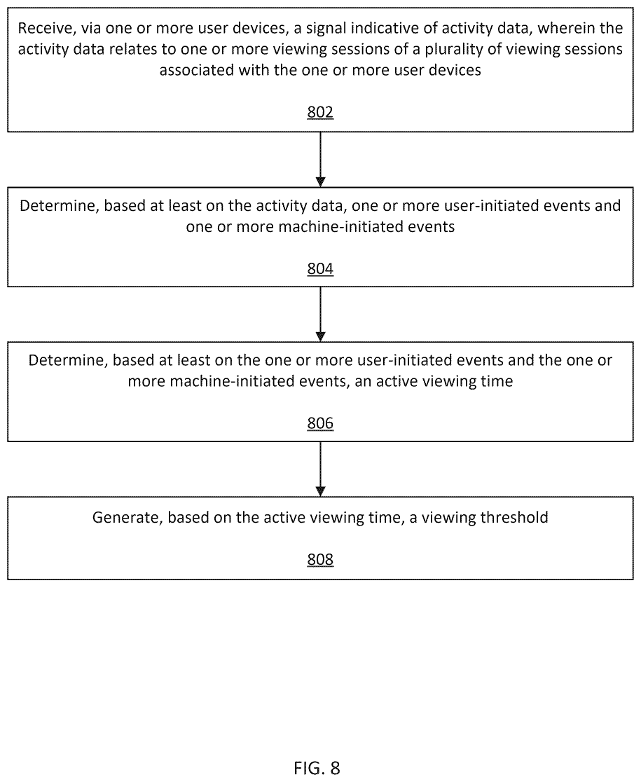

FIG. 8 is a flowchart of an example process 800. In some implementations, one or more process blocks of FIG. 8 may be performed by a device or devices. As shown in FIG. 8, process 800 may include receiving a signal, at 802. The signal may be received via one or more user devices such as content devices, user premises equipment, video players, or set-top boxes, for example. Other devices may be used. The signal may be indicative of activity data. As an example, the activity data may relate to one or more viewing sessions (e.g., of a plurality of viewing sessions) associated with the one or more user devices. The signal may comprise a status signal.

Process 800 may include determining one or more user-initiated events and one or more machine-initiated events, at 804. The determining of the one or more user-initiated events and one or more machine-initiated events may be based at least on the activity data. For example, information may be accessed from the signal and may be analyzed to determine one or more user-initiated events and one or more machine-initiated events.

As further shown in FIG. 8, process 800 may include determining, based at least on the one or more user-initiated events and the one or more machine-initiated events, an active viewing time (block 806). For example, a device may determine, based at least on the one or more user-initiated events and the one or more machine-initiated events, an active viewing time, as described above. As also shown in FIG. 8, process 800 may include generating, based on the active viewing time, a viewing threshold (block 808). For example, a device may generate, based on the active viewing time, a viewing threshold, as described above. Advertisement content may be determined based, at least in part, on the viewing threshold. As an example, the next advertisement content presented may be determined based, at least in part, on the viewing threshold. As a further example, a series of advertisement content presented may be determined based, at least in part, on the viewing threshold.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

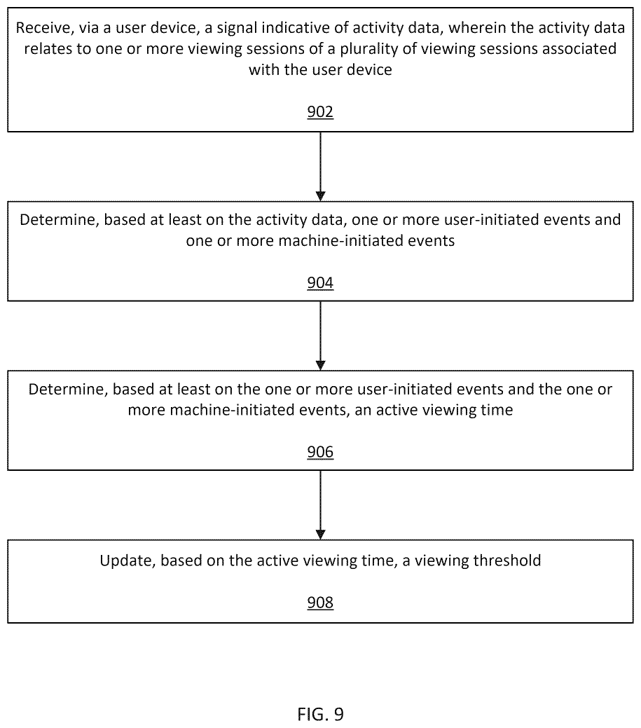

FIG. 9 is a flowchart of an example process 900. In some implementations, one or more process blocks of FIG. 9 may be performed by a device.

As shown in FIG. 9, process 900 may include receiving, a signal, at 902, The signal may be received via a user device, such as a content device, user premises equipment, or a set top box, for example. Other devices may be used. The signal may be indicative of activity data. As an example, the activity data may relate to one or more viewing sessions (e.g., of a plurality of viewing sessions) associated with the user devices. The signal may comprise a status signal.

Process 900 may include determining one or more user-initiated events and one or more machine-initiated events, at 904. The determining of the one or more user-initiated events and one or more machine-initiated events may be based at least on the activity data. For example, information may be accessed from the signal and may be analyzed to determine one or more user-initiated events and one or more machine-initiated events.

Process 900 may include determining, based at least on one or more user-initiated events and the one or more machine-initiated events, an active viewing time, at 906. For example, a device may determine, based at least on the one or more user-initiated events and the one or more machine-initiated events, an active viewing time, as described above. As also shown in FIG. 9, process 900 may include updating, based on the active viewing time, a viewing threshold at 908. For example, a device may update, based on the active viewing time, a viewing threshold, as described above. Advertisement content may be determined based, at least in part, on the viewing threshold

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

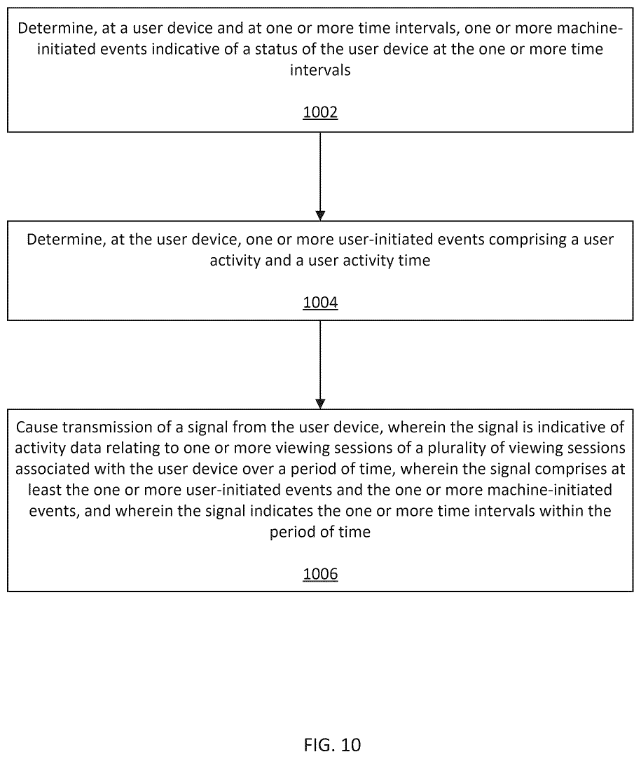

FIG. 10 is a flowchart of an example process 1000. In some implementations, one or more process blocks of FIG. 10 may be performed by a device or devices. As shown in FIG. 10, process 1000 may include determining, at a user device and at one or more time intervals, one or more machine-initiated events indicative of a status of the user device at the one or more time intervals, at 1002.

Process 1000 may include determining, at the user device, one or more user-initiated events having user activity and user activity time, at 1004. The determining of the one or more user-initiated events and one or more machine-initiated events may be based at least on the activity data. For example, device may determine, at the user device, one or more user-initiated events having a user activity and a user activity time, as described above.

Process 1000 may include causing transmission of a signal from the user device, where the signal is indicative of activity data relating to one or more viewing sessions of a plurality of viewing sessions associated with the user device over a period of time, where the signal may include at least the one or more user-initiated events and the one or more machine-initiated events, and where the signal indicates the one or more time intervals within the period of time, at 1006. The signal may comprise a status signal.

The signal may be used to create and/or update a viewing threshold. Advertisement content may be determined based, at least in part, on the viewing threshold.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

Example Clause A: A method comprising: receiving, via one or more user devices, a signal indicative of activity data, wherein the activity data relates to one or more viewing sessions of a plurality of viewing sessions associated with the one or more user devices; determining, based at least on the activity data, one or more user-initiated events and one or more machine-initiated events; determining, based at least on the one or more user-initiated events and the one or more machine-initiated events, an active viewing time; and generating, based on the active viewing time, a viewing threshold.

Example Clause B: The method of Example Clause A, wherein the one or more user devices comprise a video player.

Example Clause C: The method of Example Clause A or Example Clause B, wherein the receiving the signal is at regular intervals.

Example Clause D: The method of any one of Example Clauses A-C, wherein the signal comprises incremental activity data based on one or more time intervals.

Example Clause E: The method of any one of Example Clauses A-D, wherein the one or more user-initiated events comprises changing a channel, adjusting an audio volume, or trick play commands, or a combination thereof.

Example Clause F: The method of any one of Example Clauses A-E, wherein the one or more machine-initiated events comprises initiation of a screen saver, system reboot, or software update, or a combination thereof.

Example Clause G: The method of any one of Example Clauses A-F, wherein at least one of the one or more user-initiated events is a power up event.

Example Clause H: The method of any one of Example Clauses A-G, wherein at least one of the one or more user-initiated events comprises engagement of a key on a remote control.

Example Clause I: The method of any one of Example Clauses A-H, wherein at least one of the one or more user-initiated events comprises a voice command.

Example Clause J: The method of any one of Example Clauses A-I, wherein at least one of the one or more user-initiated events comprises a ghost key press.

Example Clause K: The method of any one of Example Clauses A-J, wherein the ghost key press comprises engagement of a power button.

Example Clause L: The method of any one of Example Clauses A-K, wherein the activity data comprises one or more of a status of the user device, a user activity, a user activity time, a start time associated with the one or more viewing sessions, or an offset from the start time associated with the one or more viewing sessions.

Example Clause M: The method of any one of Example Clauses A-L, wherein the determining the active viewing time comprises: determining a first set of one or more viewing sessions of the plurality of viewing sessions that satisfy a filter threshold; and determining a distribution of a second set of one or more viewing sessions of the plurality of viewing sessions, wherein the active viewing time is determined based on at least the first set of one or more viewing sessions and the second set of one or more viewing sessions.

Example Clause N: The method of any one of Example Clauses A-M, wherein the filter threshold comprises one or more of exhibiting a start time at about four hours from the most recent user-initiated event, exhibiting an end time associated with a reboot, exhibiting no activity for more than four hours.

Example Clause O: The method of any one of Example Clauses A-N, wherein the viewing threshold comprises one or more of a time from a viewing session start time or a time from the most recent user-initiated event.

Example Clause P: The method of any one of Example Clauses A-O, further comprising determining advertisement content based, at least in part, on the viewing threshold.

Example Clause Q: A method comprising: receiving, via a user device, a signal indicative of activity data, wherein the activity data relates to one or more viewing sessions of a plurality of viewing sessions associated with the user device; determining, based at least on the activity data, one or more user-initiated events and one or more machine-initiated events; determining, based at least on the one or more user-initiated events and the one or more machine-initiated events, an active viewing time; updating, based on the active viewing time, a viewing threshold.

Example Clause R: The method of Example Clause Q, wherein the user device comprises a video player.

Example Clause S: The method of Example Clause Q or Example Clause R, wherein the receiving the signal is at regular intervals.

Example Clause T: The method of any one of Example Clauses Q-S, wherein the signal comprises incremental activity data based on one or more time intervals.

Example Clause U: The method of any one of Example Clauses Q-T, wherein the one or more user-initiated events comprises changing a channel, adjusting an audio volume, or trick play commands, or a combination thereof.

Example Clause V: The method of any one of Example Clauses Q-U, wherein the one or more machine-initiated events comprises initiation of a screen saver, system reboot, or software update, or a combination thereof.

Example Clause W: The method of any one of Example Clauses Q-V, wherein at least one of the one or more user-initiated events is a power up event.

Example Clause X: The method of any one of Example Clauses Q-W, wherein at least one of the one or more user-initiated events comprises engagement of a key on a remote control.

Example Clause Y: The method of any one of Example Clauses Q-X, wherein at least one of the one or more user-initiated events comprises a voice command.

Example Clause Z: The method of any one of Example Clauses Q-Y, wherein the ghost key press comprises engagement of a power button.

Example Clause AA: The method of any one of Example Clauses Q-Z, wherein at least one of the one or more user-initiated events comprises a ghost key press.

Example Clause AB: The method of any one of Example Clauses Q-AA, wherein the activity data comprises one or more of a status of the user device, a user activity, a user activity time, a start time associated with the one or more viewing sessions, or an offset from the start time associated with the one or more viewing sessions.

Example Clause AC: The method of any one of Example Clauses Q-AB, wherein the viewing threshold comprises one or more of a time from a viewing session start time or a time from the most recent user-initiated event.

Example Clause AD: The method of any one of Example Clauses Q-AC, further comprising determining advertisement content based, at least in part, on the viewing threshold.

Example Clause AE: A method comprising: determining, at a user device and at one or more time intervals, one or more machine-initiated events indicative of a status of the user device at the one or more time intervals; determining, at the user device, one or more user-initiated events comprising a user activity and a user activity time; and causing transmission of a signal from the user device, wherein the signal is indicative of activity data relating to one or more viewing sessions of a plurality of viewing sessions associated with the user device over a period of time, wherein the signal comprises at least the one or more user-initiated events and the one or more machine-initiated events, and wherein the signal indicates the one or more time intervals within the period of time.

Example Clause AF: The method of Example Clause AE, wherein the user device comprise a video player.

Example Clause AG: The method of Example Clause AE or Example Clause AF, wherein the one or more user-initiated events comprises changing a channel, adjusting an audio volume, or trick play commands, or a combination thereof.

Example Clause AH: The method of any one of Example Clauses AE-AG, wherein the one or more machine-initiated events comprises initiation of a screen saver, system reboot, or software update, or a combination thereof.

Example Clause AI: The method of any one of Example Clauses AE-AH, wherein at least one of the one or more user-initiated events is a power up event.

Example Clause AJ: The method of any one of Example Clauses AE-AI, wherein at least one of the one or more user-initiated events comprises engagement of a key on a remote control.

Example Clause AK: The method of any one of Example Clauses AE-AJ, wherein at least one of the one or more user-initiated events comprises a voice command.

Example Clause AL: The method of any one of Example Clauses AE-AK, wherein at least one of the one or more user-initiated events comprises a ghost key press.

Example Clause AM: The method of any one of Example Clauses AE-AL, wherein the ghost key press comprises engagement of a power button.

Example Clause AN: The method of any one of Example Clauses AE-AM, wherein the activity data comprises one or more of a status of the user device, a user activity, a user activity time, a start time associated with the one or more viewing sessions, or an offset from the start time associated with the one or more viewing sessions.

Example Clause AO: The method of any one of Example Clauses AE-AN, wherein the signal is used to update a viewing threshold, and further comprising determining advertisement content based, at least in part, on the viewing threshold.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, via one or more user devices, a signal indicative of activity data, wherein the activity data relates to one or more viewing sessions of a plurality of viewing sessions associated with the one or more user devices;
determining, based at least on the activity data, one or more user-initiated events and one or more machine-initiated events;
determining, based at least on the one or more user-initiated events and the one or more machine-initiated events, an active viewing time; and
generating, based on the active viewing time, a viewing threshold.

2. The method of claim 1, wherein the one or more user devices comprise a video player.

3. The method of claim 1, wherein the receiving the signal is at regular intervals.

4. The method of claim 1, wherein the signal comprises incremental activity data based on one or more time intervals.

5. The method of claim 1, wherein the one or more user-initiated events comprises changing a channel, adjusting an audio volume, or trick play commands, or a combination thereof.

6. The method of claim 1, wherein the one or more machine-initiated events comprises initiation of a screen saver, system reboot, or software update, or a combination thereof.

7. The method of claim 1, wherein the one or more user-initiated events comprises a power up event, engagement of a key on a remote control, a voice command, or a ghost key press.

8. The method of claim 1, wherein the activity data comprises one or more of a status of the one or more user devices, a user activity, a user activity time, a start time associated with the one or more viewing sessions, or an offset from the start time associated with the one or more viewing sessions.

9. The method of claim 1, wherein the determining the active viewing time comprises:
determining a first set of one or more viewing sessions of the plurality of viewing sessions that satisfy a filter threshold; and
determining a distribution of a second set of one or more viewing sessions of the plurality of viewing sessions,
wherein the active viewing time is determined based on at least the first set of one or more viewing sessions and the second set of one or more viewing sessions.

10. The method of claim 9, wherein the filter threshold comprises one or more of exhibiting a start time at about four hours from a most recent user-initiated event, exhibiting an end time associated with a reboot, exhibiting no activity for more than four hours.

11. The method of claim 1, wherein the viewing threshold comprises one or more of a time from a viewing session start time or a time from a most recent user-initiated event.

12. The method of claim 1, further comprising determining advertisement content based, at least in part, on the viewing threshold.

13. A method comprising:
receiving, via a user device, a signal indicative of activity data, wherein the activity data relates to one or more viewing sessions of a plurality of viewing sessions associated with the user device;
determining, based at least on the activity data, one or more user-initiated events and one or more machine-initiated events;
determining, based at least on the one or more user-initiated events and the one or more machine-initiated events, an active viewing time; and
updating, based on the active viewing time, a viewing threshold.

14. The method of claim 13, wherein the receiving the signal is at regular intervals.

15. The method of claim 13, wherein the signal comprises incremental activity data based on one or more time intervals.

16. The method of claim 13, wherein the one or more user-initiated events comprises changing a channel, adjusting an audio volume, or trick play commands, or a combination thereof.

17. The method of claim 13, wherein the one or more machine-initiated events comprises initiation of a screen saver, system reboot, or software update, or a combination thereof.

18. The method of claim 13, wherein the one or more user-initiated events comprises a power up event, engagement of a key on a remote control, a voice command, or a ghost key press.

19. The method of claim 13, wherein the activity data comprises one or more of a status of the user device, a user activity, a user activity time, a start time associated with the one or more viewing sessions, or an offset from the start time associated with the one or more viewing sessions.

20. The method of claim 13, wherein the viewing threshold comprises one or more of a time from a viewing session start time or a time from a most recent user-initiated event.

21. The method of claim 13, further comprising determining advertisement content based, at least in part, on the viewing threshold.

22. A method comprising:
determining, at a user device and at one or more time intervals, one or more machine-initiated events indicative of a status of the user device at the one or more time intervals;
determining, at the user device, one or more user-initiated events comprising a user activity and a user activity time; and
causing transmission of a signal from the user device, wherein the signal is indicative of activity data relating to one or more viewing sessions of a plurality of viewing sessions associated with the user device over a period of time,
wherein the signal comprises at least the one or more user-initiated events and the one or more machine-initiated events, and wherein the signal indicates the one or more time intervals within the period of time.

23. The method of claim 22, wherein the user device comprise a video player.

24. The method of claim 22, wherein the one or more user-initiated events comprises changing a channel, adjusting an audio volume, or trick play commands, or a combination thereof.

25. The method of claim 22, wherein the one or more machine-initiated events comprises initiation of a screen saver, system reboot, or software update, or a combination thereof.

26. The method of claim 22, wherein the one or more user-initiated events comprises a power up event, engagement of a key on a remote control, a voice command, or a ghost key press.

27. The method of claim 22, wherein the activity data comprises one or more of a status of the user device, a user activity, a user activity time, a start time associated with the one or more viewing sessions, or an offset from the start time associated with the one or more viewing sessions.

28. The method of claim 22, wherein the signal is used to update a viewing threshold, and further comprising determining advertisement content based, at least in part, on the viewing threshold.
